(19) United States
(12) Patent Application Publication
(10) Pub. No.: US 2018/0000177 A1
(43) Pub. Date: Jan. 4, 2018

(54) Thermochromic Articles of Apparel and Methods of Production

(71) Applicants: Beau Horner, Austin, TX (US); Nadejda Aseeva, Austin, TX (US); Kevin J. Melchiorri, Austin, TX (US)

(72) Inventors: Beau Horner, Austin, TX (US); Nadejda Aseeva, Austin, TX (US); Kevin J. Melchiorri, Austin, TX (US)

(21) Appl. No.: 15/638,359

(22) Filed: Jun. 29, 2017

Related U.S. Application Data
(60) Provisional application No. 62/355,872, filed on Jun. 29, 2016.

(51) Int. Cl. A41D 31/02; A41D 31/00; B32B 7/04; D06P 1/00; B32B 27/12

(52) U.S. Cl. CPC A41D 31/02; D06P 1/004; B32B 27/12; B32B 7/04; A41D 31/0033; B32B 2250/03; A41D 2500/50; A41D 2400/10; A41D 2600/10; B32B 2307/304; B32B 2307/4026; B32B 2437/00

(57) ABSTRACT

Embodiments provide thermochromic articles of apparel and methods of production. The article of apparel may comprise a textile layer and a thermochromic portion that includes at least one set of thermochromic molecules that affixed to the textile layer. A heat protective layer may be positioned on a first surface of the thermochromic portion.

### CROSS-REFERENCE TO RELATED APPLICATIONS

This application claims priority to U.S. Provisional Patent Application Number 62/355,872, filed Jun. 29, 2016, which is incorporated by reference in its entirety.

### FIELD OF THE INVENTION

The present disclosure relates to thermochromic articles of apparel, specifically athletic outerwear/apparel and athleisure, and methods of production.

### BACKGROUND OF THE INVENTION

Thermochromic dyes are popular in a number of different articles, including cups, food product containers, and certain types of textiles. The dyes may be utilized for aesthetics as well as for purposes such as heat exhaustion detection, food temperature monitoring, etc.

Athletic apparel is a large industry with a high demand for innovation. Men, women, and children alike utilize this apparel for various recreational activities, as well as just for everyday use. Thermochromic dyes have been utilized mainly in leisure clothing including cotton fibers, which may include T-shirts, leans, etc. Thermochromic dyes have been attempted to be incorporated into athletic apparel, but the efforts have fallen short due to the poor adhesion between the dyes and the synthetic yarns and fibers in the athletic apparel. Because of this, the dyes tend to wash out when the apparel is washed. Efficient means are needed in order to properly affix thermochromic inks to athletic apparel and other synthetic fabrics.

Athletic apparel is a large industry with a high demand for innovation. Men, women, and children alike utilize this apparel for various recreational activities, as well as just for everyday use.

### BRIEF SUMMARY OF THE INVENTION

The disclosed subject matter provides articles of apparel, more specifically athletic outerwear/apparel comprising thermochromic molecules. The apparel may comprise various textile and polymer constructions that may interact with thermochromic molecules.

An article of apparel may comprise a textile layer and a thermochromic portion affixed to the textile layer. The thermochromic portion may comprise at least one set of thermochromic molecules. A heat protective layer may comprise a plurality of heat resistant molecules and may be positioned on a first surface of the thermochromic portion.

The disclosure may further include a thermochromic patch comprising a thermochromic portion affixable to a portion of a textile. The thermochromic portion may comprise at least one set of thermochromic molecules. A heat protective layer,may be positioned on a first portion of the thermochromic portion. The heat protective layer may prevent transmission of heat from an external environment to the thermochromic portion.

The disclosure may further comprise a method for producing a thermochromic article of apparel. The method may comprise providing a textile layer. A thermochromic comprising at least one set of thermochromic molecules may then be affixed to the textile layer. A heat protective layer may be applied and positioned on a first portion of the thermochromic portion.

### BRIEF DESCRIPTION OF THE DRAWINGS

The novel features believed characteristic of the disclosed subject matter will be set forth in any claims that are filed. The disclosed subject matter itself, however, further objectives, and advantages thereof, will best be understood by reference to the following detailed description of an illustrative embodiment when read in conjunction with the accompanying drawings, wherein:

FIG. 1 displays a front view of an article of apparel in accordance with embodiments. (prior art) PANTS

FIG. 2 displays a front view of an article of apparel including an applied thermochromic portion in accordance with embodiments.

FIG. 3A displays a layer view of an article of apparel in accordance with embodiments.

FIG. 3B displays a layer view of an article of apparel including an intermediary layer in accordance with embodiments.

FIG. 4 displays a layer view of an article of apparel including an applied thermochromic portion in accordance with embodiments. (color of thermochromic ink goes from color of pants to another color)

FIG. 5 displays a front view of a multi-layered thermochromic article of apparel in accordance with embodiments. (includes laser cut layer)

FIG. 6 displays a front view of a thermochromic article of apparel including open portions in accordance with embodiments.

FIG. 7 displays a front view of an article of apparel including a pattern and at least one thermochromic portion in accordance with embodiments.

FIG. 8 displays a zoomed-in view of a thermochromic portion including at least one type of thermochromic molecule in accordance with embodiments.

FIG. 9 displays a zoomed-in view of an applied thermochromic portion in accordance with embodiments.

FIG. 10 displays various fiber configurations in accordance with embodiments.

FIG. 11 displays a sectional view of a thermochromic patch in accordance with embodiments.

FIG. 12 displays a zoomed-in view of an applied thermochromic patch positioned within an article of apparel in accordance with embodiments.

FIG. 13 displays a method for producing a thermochromic article of apparel in accordance with embodiments.

FIG. 14 displays a method for producing yarn in accordance with embodiments.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The disclosure may relate to athletic apparel such as, but not limited to, activewear, athleisure, pants, shirts, skirts, shorts, skorts, etc. More specifically, the disclosure may relate to apparel including various configurations utilizing thermochromic molecules, as well as dye and pigment molecules.

Embodiments may include various configurations such as, but not limited to woven/knit apparel with multiple layers and woven/knit apparel including screen printed/adhered polymeric material.

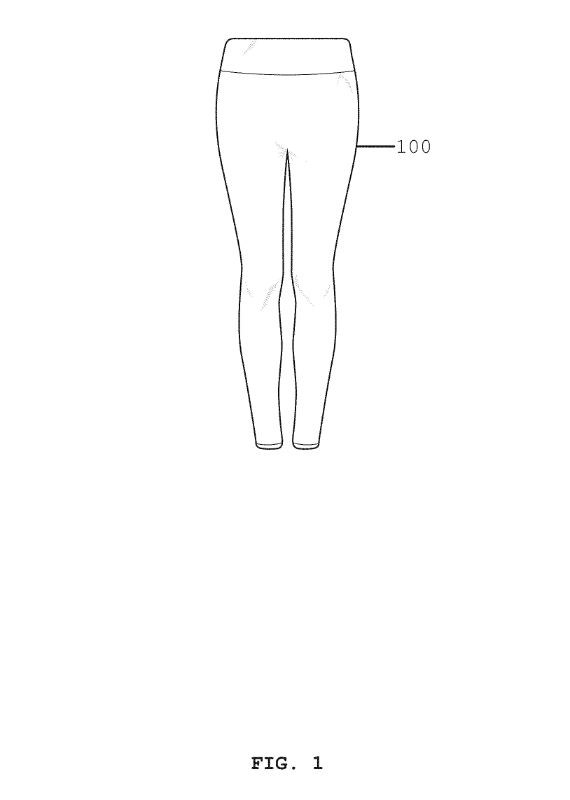

FIG. 1 displays a front view of an article of apparel 100 in accordance with embodiments. Article 100 may be classified as an athletic article, which may imply that article 100 may be made to withstand conditions harsher than that which a normal article may withstand. Article 100 may comprise at least one of a plurality of synthetic fibers/yarns and a plurality of natural fibers/yarns. When worn by an individual, article 100 may be exposed to harsh conditions that may include heat, sweat, water, etc. Additionally, article 100 may put through a washing and drying cycle that may be harsh on the components of the article.

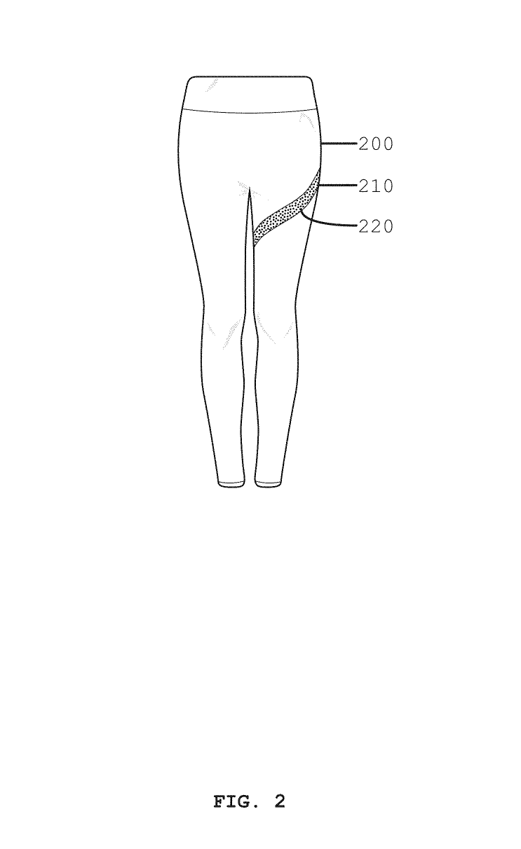

FIG. 2 displays a front view of an article of apparel 200 including an applied thermochromic portion 210 in accordance with embodiments. The article of apparel 200 may comprise a textile layer 230 and a thermochromic portion 210 affixed to the textile layer 230. The thermochromic portion 210 may comprise at least one set of thermochromic molecules 220. In embodiments, the thermochromic portion 210 may be any shape and may be positioned on any predetermined portion of the article 200. When an individual wears the article 200, heat may be expelled from the individual and may travel to the thermochromic portion 210. If the heat expelled heats the thermochromic molecules 220 above a specific activation temperature, the thermochromic molecules 220 may change from one color to another color. This color change may not only be aesthetically pleasing, but also may act as a signal to show that the individual is within a specific temperature range (indicating that the individual may be overheating, is warmed up for a certain purpose, etc.).

The predetermined portion may include an area that may be adjacent an individual's muscle when an individual is wearing the article 200. When the muscle is being used for activity, the muscle may give off more heat than other parts of the body, allowing for the heat to transfer to the thermochromic portion 210 and change the color of the thermochromic portion 210. Depending on the standard and activation temperatures of the thermochromic molecules, thermoclyromic portions 210 with specific thermochromic molecules 220 may be placed on different areas of the body, depending on how much heat is released from the different areas.

In embodiments, the thermochromic portion 210 may comprise an elastic polymer. The elastic polymer may be at least one of a binding agent, a polyurethane, a vinyl polymer, and HDPE. In embodiments, the thermochromic portion 210 may comprise a cross-linked polymer.

In embodiments, the thermochromic portion 210 may be affixed to the textile layer via at least one method of self-adhesion, a binding agent, ultrasonic welding, and heat treatment.

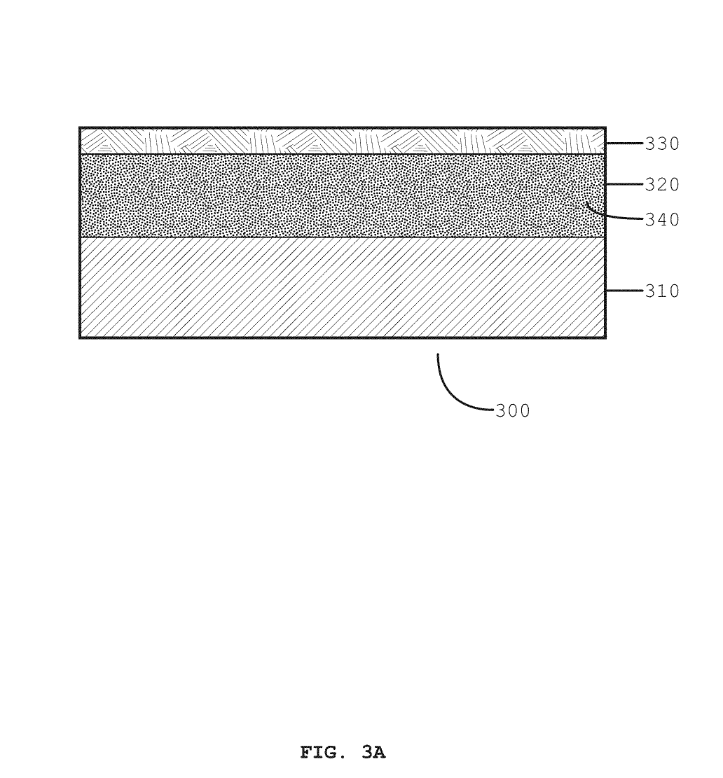

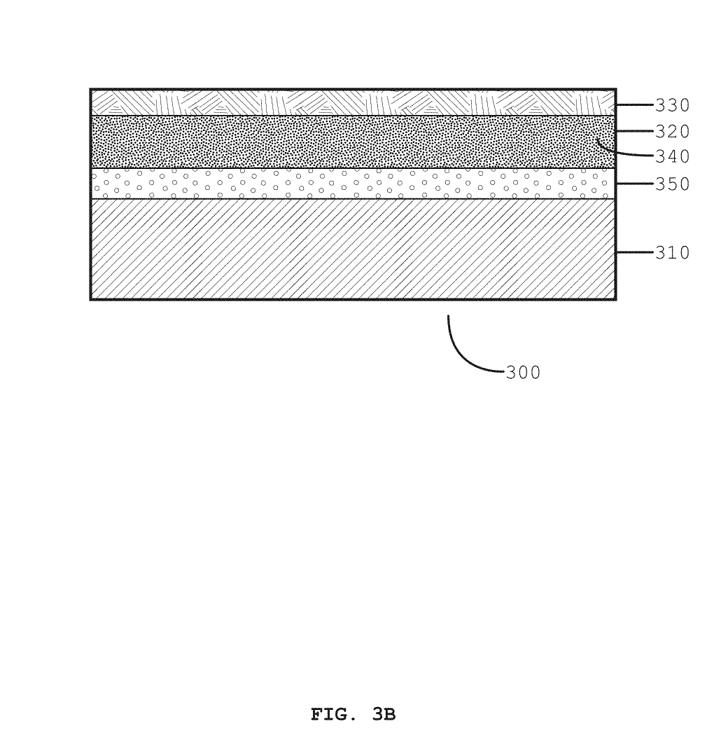

FIG. 3A displays a layer view of an article of apparel 300 in accordance with embodiments. A textile layer 310 may be provided as part of an article of apparel 300. A thermochromic portion 320 may be affixed to the textile layer 310. The thermochromic portion 320 may comprise at least one set of thermochromic molecules 340. A heat protective layer 330 comprising a plurality of heat resistant molecules may be positioned on a first surface of the thermochromic portion 320. The heat protective layer 330 may comprise a plurality of blocking and/or absorbing compounds dispersed within a polymer layer. The plurality of blocking and/or absorbing molecules may be capable of blocking, reflecting, and/or absorbing infrared. waves, which may keep heat from penetrating into the thermochromic portion 320 and therefore keeps the thermochromic molecules 340 from changing color. The layered setup disclosed may only allow heat to the thermochromic portion 320 via an internal source (such as an individual's body) as opposed to an external source (such as infrared waves from the sun). This ability may provide an accurate representation of body heat and the temperature of the body heat expelled from an individual's body.

In order to be able to view the changing of color of the thermochromic molecules 340, in embodiments, the polymer layer may be at least one of translucent and transparent. In embodiments, the heat protective layer 330 may comprise at least one of silicon dioxide, a metal oxide, a polyphosphazene, and a silicone polymer.

FIG. 3B displays a layer view of an article of apparel including an intermediary layer 350 in accordance with embodiments. The intermediary layer 350 may be positioned. between the thermochromic portion and the textile layer. The intermediary layer 350 may have a higher thermal conductivity than the textile layer 310 and may provide heat more efficiently to the thermochromic portion.

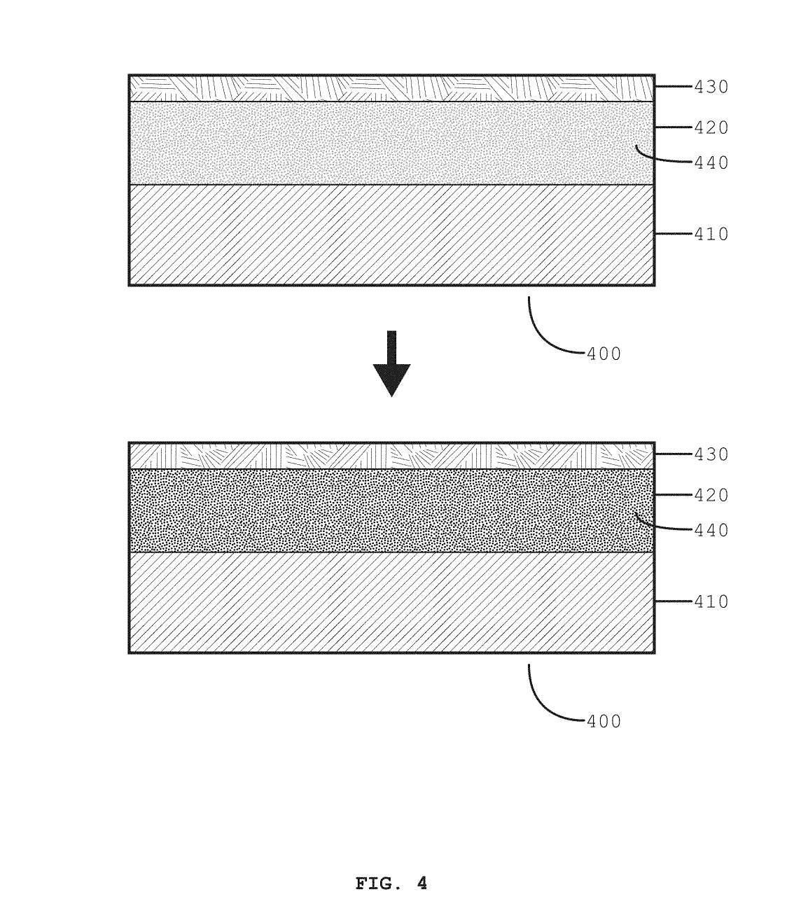

FIG. 4 displays a layer view of an article of apparel including an applied thermochromic portion 420 in accordance with embodiments. The thermochromic portion 420 may comprise a plurality of thermochromic molecules 440 that may comprise a standard color that matches main color of the textile layer 410. When heat is applied and the molecules 440 are brought above their activation temperature, the molecules 440 may change to an activation color, which is a color different than that of the standard color and the main color. This color change may not only be aesthetically pleasing, but also may act as a signal to show that the individual is within a specific temperature range (indicating that the individual may be overheating, is warmed up for a certain purpose, etc.).

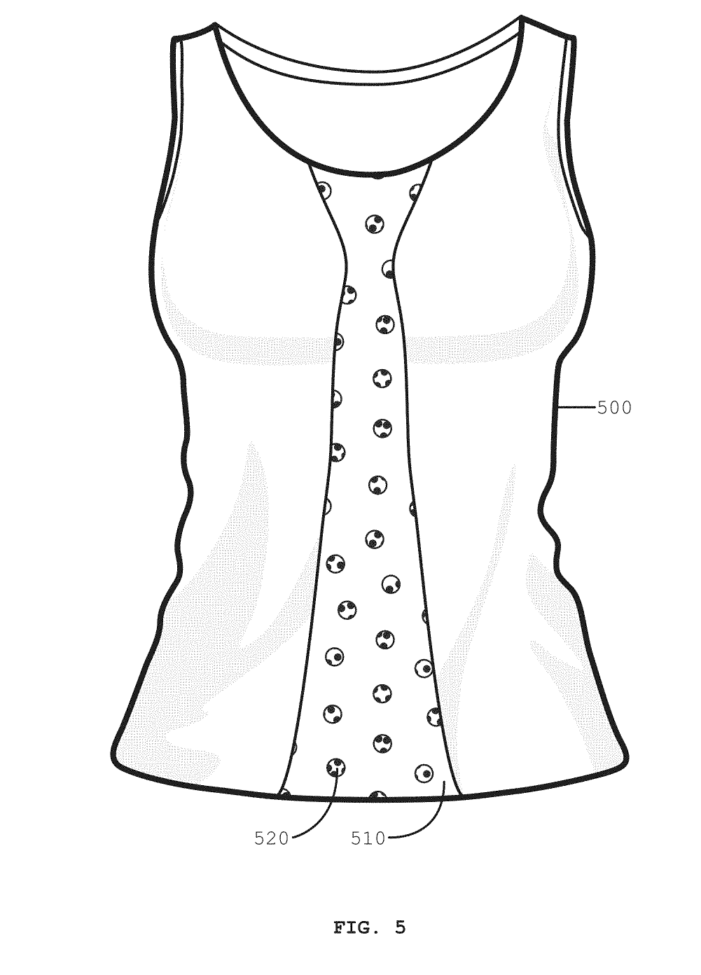

FIG. 5 displays a front view of a multi-layered thermochromic article of apparel 500 accordance with embodiments. The article 500 may comprise a second fabric layer 510 that may cover a thermochromic portion 1520. The second fabric layer may comprise at least one orifice that may show the thermochromic portion 520 and the thermochromic molecules in a unique way. The molecules 520 in the thermochromic portion 520 may be the same color as the article 500 or may be a color different than that of the article 500.

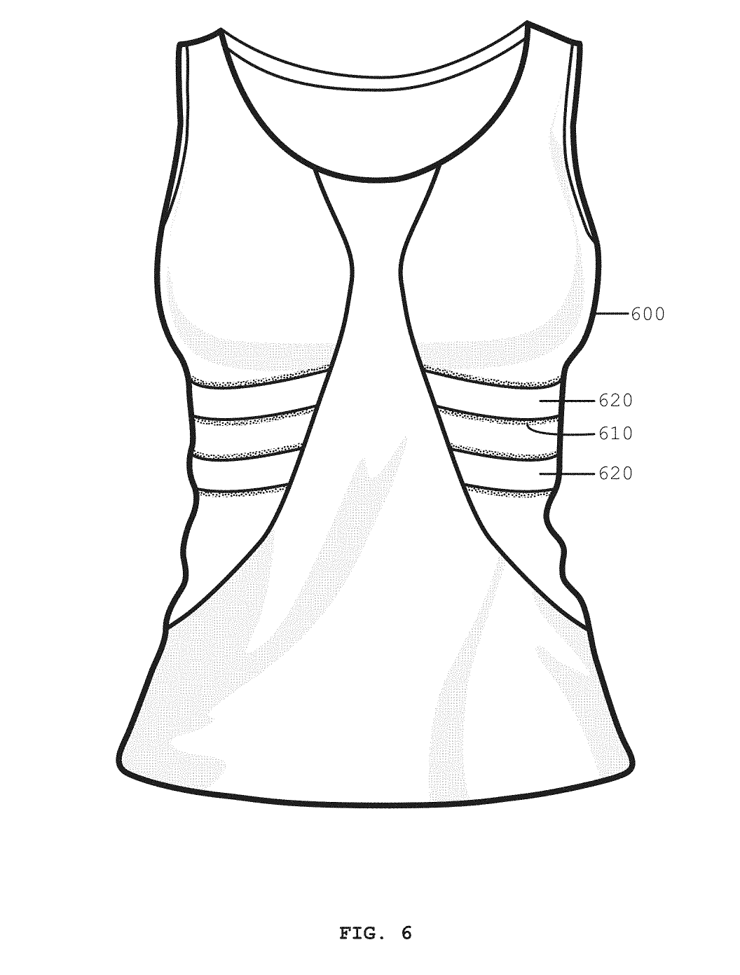

FIG. 6 displays a front view of a thermochromic article of apparel 600 including orifices 620 in accordance with embodiments. Orifices 620 are shown located on the rib section of the article 600, but may be located in other portions of the article 600. Thermochromic portions 610 including thermochromic molecules may be positioned around the borders of the orifices 620 so that body heat from an individual wearing the article 600 makes more direct contact with the thermochromic portions 610, thus more quickly activating the thermochromic molecules (as opposed to when the thermochromic portions 610 are located on an outside surface of the article).

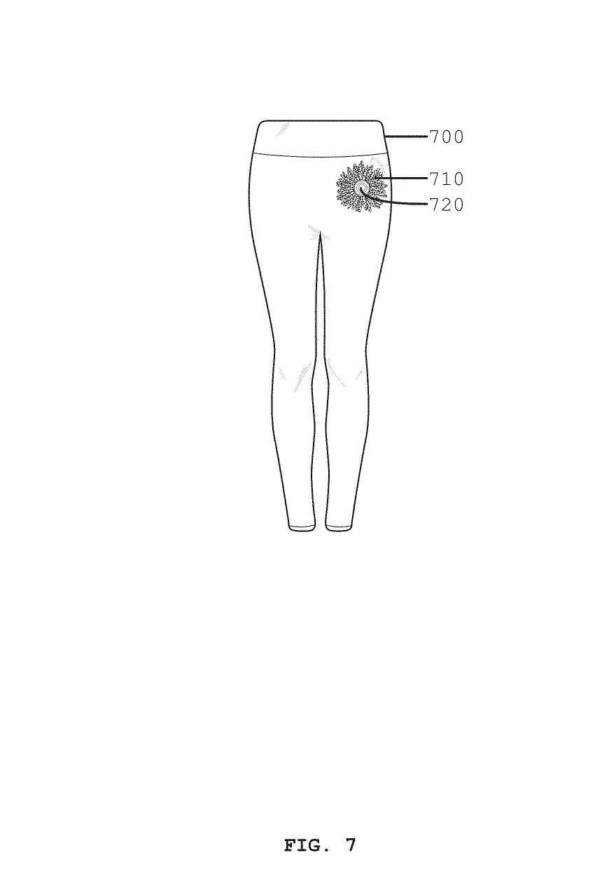

FIG. 7 displays a front view of an article of apparel 700 including a pattern 720 and at least one thermochromic portion 710 in accordance with embodiments. Pattern 720 may be positioned on the article 700 and may be comprised of at least one of a patch, ink, polymer, etc. A portion of the pattern 720 may be overlaid with a thermochromic portion 710 that may match the shape of the portion of the pattern 720, providing a unique visual when molecules within the thermochromic portion are heated above their activation temperature.

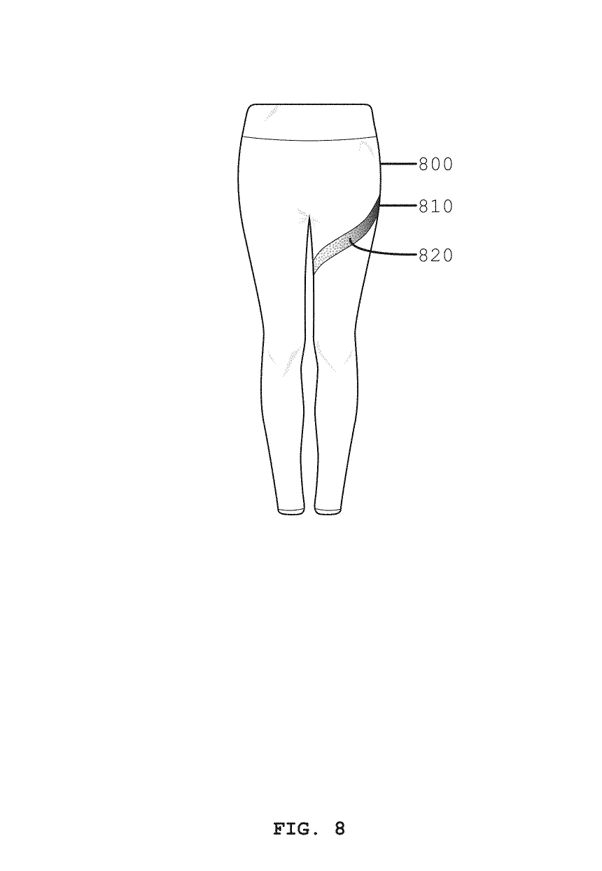

FIG. 8 displays a zoomed-in view of a thermochromic portion 810 including at least one type of thermochromic molecule in accordance with embodiments. Thermochromic portion 810 may comprise at least one set of a plurality of thermochromic molecules. In this instance, the colors of the thermochromic molecules are separated in a faded pattern and are organized from color to color. When heated to their activation temperature, the thermochromic molecules 820 may change to colors that show the same faded pattern, or may show a completely different pattern altogether.

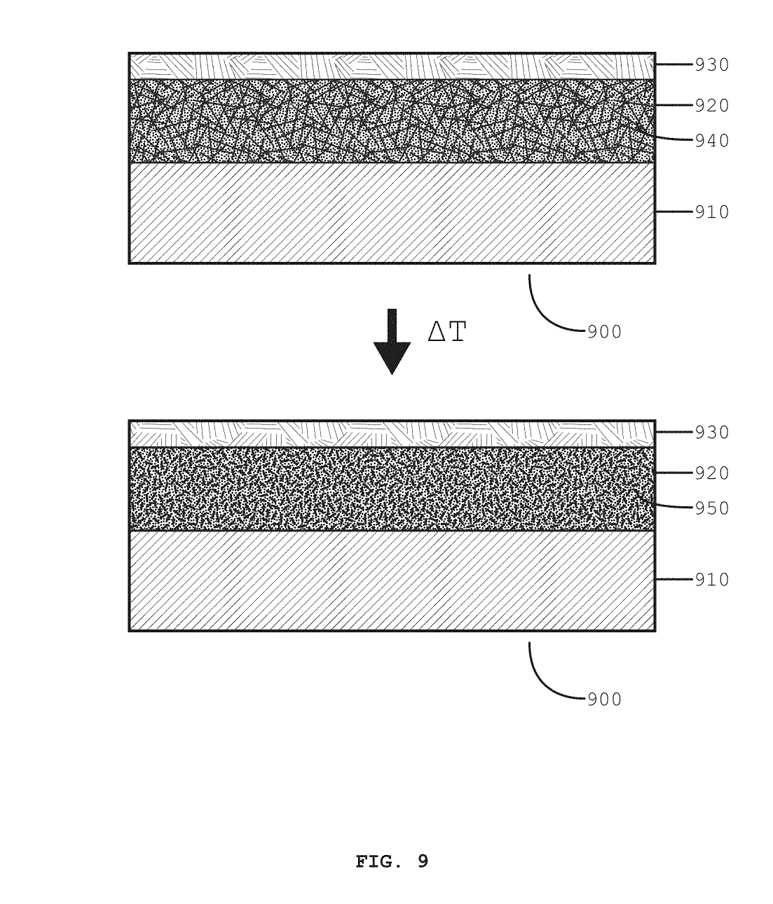

FIG. 9 displays a zoomed-in view of an applied thermochromic portion 920 in accordance with embodiments. Adjacent the textile layer 910 is the mixed dye layer 920, which includes a plurality of thermochromic molecules 940 and non-thermochromic molecules 940. Adjacent the mixed dye layer is the heat protective layer 930. The mixed dye layer 920 may change to a different color 950 at a specific activation temperature of the thermochromic molecules. For example, if the thermochromic molecules 940 are blue below the activation temperature and are mixed with non-thermochromic molecules that are red (and if the thermochromic molecules 950 become yellow at the activation temperature), the entire mixed dye layer 920 may change from purple to orange because the colors of the thermochromic and non-thermochromic molecules 940,950 may mix to create those colors. Many variations of this combination may be utilized to create unique color changing transitions.

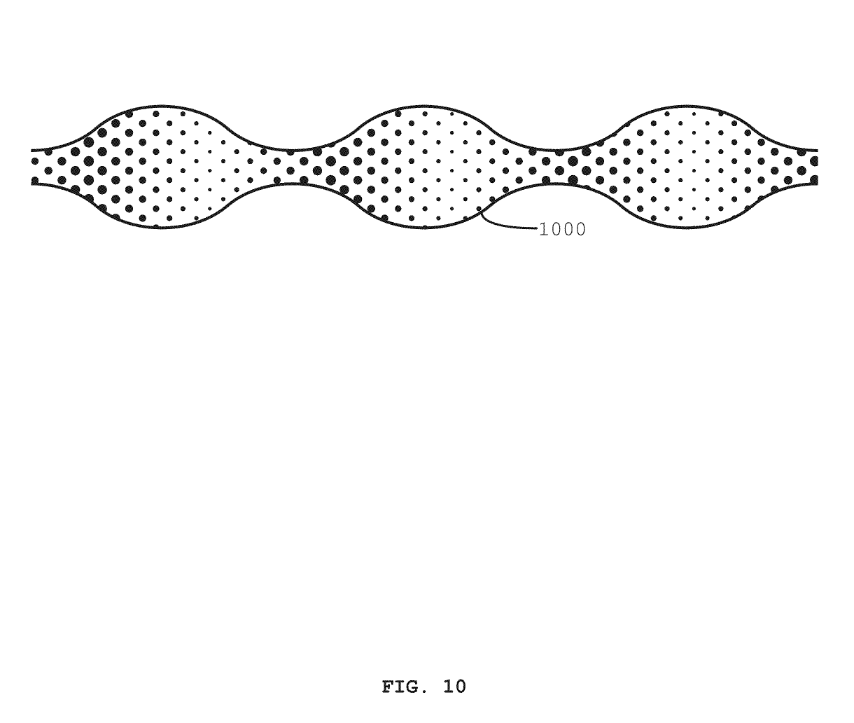

In embodiments, single fibers 1000 may comprise a varying thickness at different points in the fibers, such as that shown in FIG. 10. In embodiments, the thickness of a fiber may alternate from thick to thin in a substantially uniform pattern. (see FIG. 10). The creation of these fibers may be carried out in one or more different ways. In embodiments, a spinneret may comprise a shape restrictor element that may close off portions of holes found in the spinneret from which fibers may be drawn. The shape restrictor element may shape the fiber so that the fiber may have a smaller thickness or dimension. The shape restrictor element may be a single piece or may be multiple pieces that may fit over a spinneret. In embodiments, the shape restrictor element may protrude and retract from a position in front of the holes of the spinneret at specific intervals so that fibers may comprise equal lengths of larger diameters and smaller lengths of diameters. In embodiments, the shape restrictor element may be connected to a computing system that may control the shape restrictor element to protrude and retract from a position in front of the holes of the spinneret. In embodiments, the shape restrictor element may be positioned within the spinneret.

In embodiments, synthetic fibers may comprise varying thicknesses at different points in the fibers. In embodiments, the synthetic fibers of varying thicknesses may be incorporated into at least one of a core-spun yarn core and a core-spun yarn sheath. The additional surface area may provide an increased wicking rate for sweat being wicked from an individual's body, which may deliver body heat from the sweat to the thermochromic portion, which may change the color of the thermochromic molecules at a faster rate.

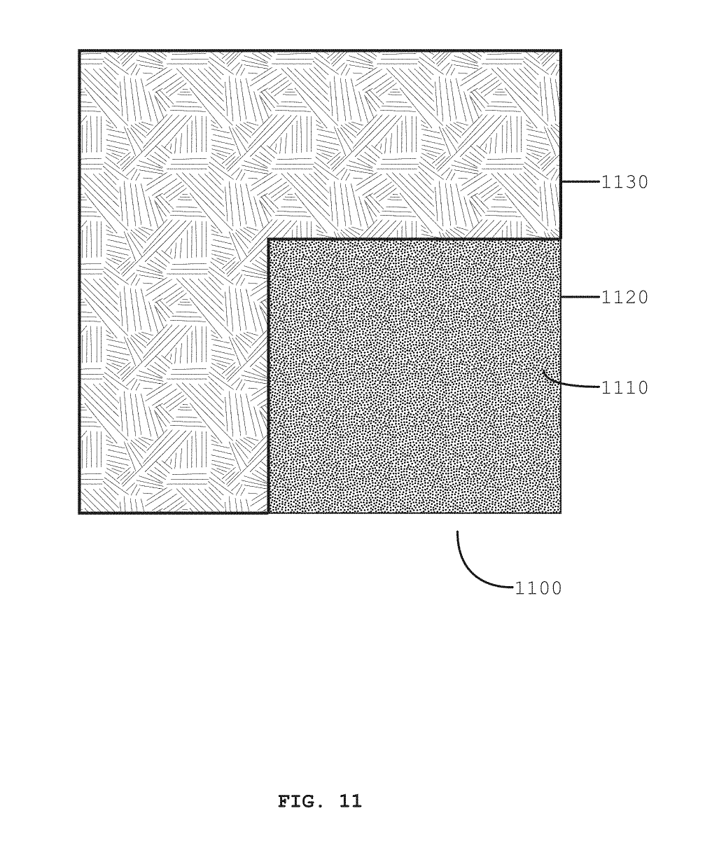

FIG. 11 displays a sectional view of thermochromic patch 1100 in accordance with embodiments. The thermochromic patch may comprise a thermochromic portion 1120 that may be affixable to a portion of a textile. The thermochromic portion 1120 may comprise at least one set of thermochromic molecules 1110. A heat protective layer 1130 may be positioned on a first portion of the thermochromic portion 1120. The heat protective layer 1130 may prevent transmission of heat from an external environment to the thermochromic portion 1120, thus keeping the molecules from changing color from an external source. Patch 1100

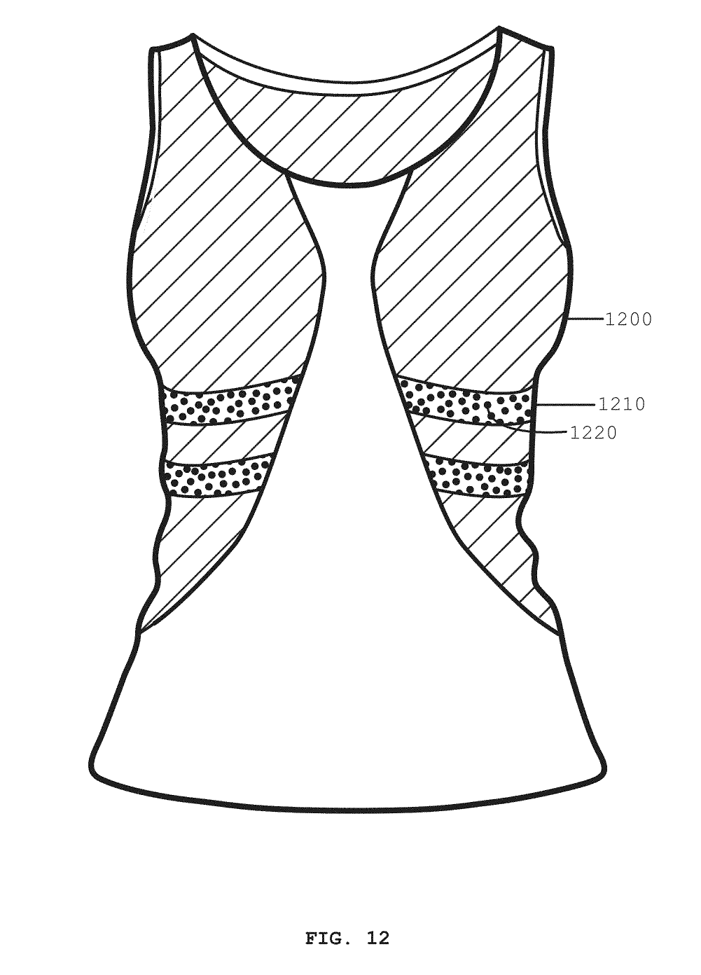

FIG. 12 displays a zoomed-in view of an applied thermochromic patch 1210 positioned within an article of apparel 1200 in accordance with embodiments. The patch 1210 may comprise a plurality of thermochromic molecules 1220. Within the article 1200 may be at least one orifice that may each be covered by patch 1210. It is advantageous to have the patch 1210 covering the orifice so that the patch 1210 may contact skin on an individual, which may provide body heat directly to the patch 1210 and may more quickly heat the thermochromic molecules 1220 (thus changing the color of the thermochromic molecules 1220).

In embodiments, the thermochromic portion 1120 may comprise an elastic polymer.

In embodiments, the thermochromic portion 1120 may be affixed to the article 1200 via at least one of self-adhesion, a binding agent, ultrasonic welding, and heat treatment.

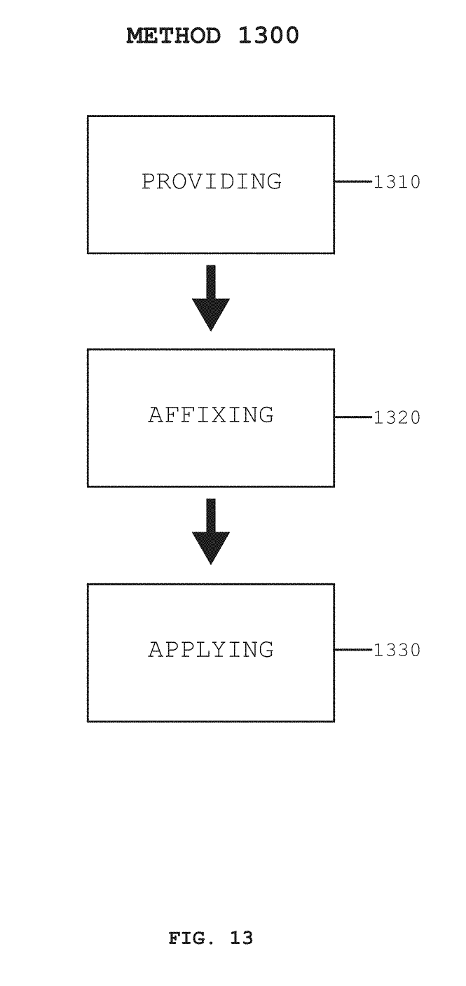

FIG. 13 displays a method for producing a thermochromic article of apparel in accordance with embodiments. Method 1300 may comprise providing a textile layer. A thermochromic portion may be affixed to the textile layer, wherein the thermochromic portion comprises at least one set of thermochromic molecules. A heat protective layer may then be applied to a first portion of the thermochromic portion. In embodiments, the thermochromic portion may be affixed to the textile layer via at least one of self-adhesion, a binding agent, ultrasonic welding, and heat treatment.

In embodiments, the thermochromic portion may be positioned along a border of an orifice defined within the textile portion.

In embodiments, method 1400 may further comprise applying a non-thermochromic dye including a first color. In this embodiment, at least one set of thermochromic molecules is colorless at a first temperature range and a second color at a second temperature range.

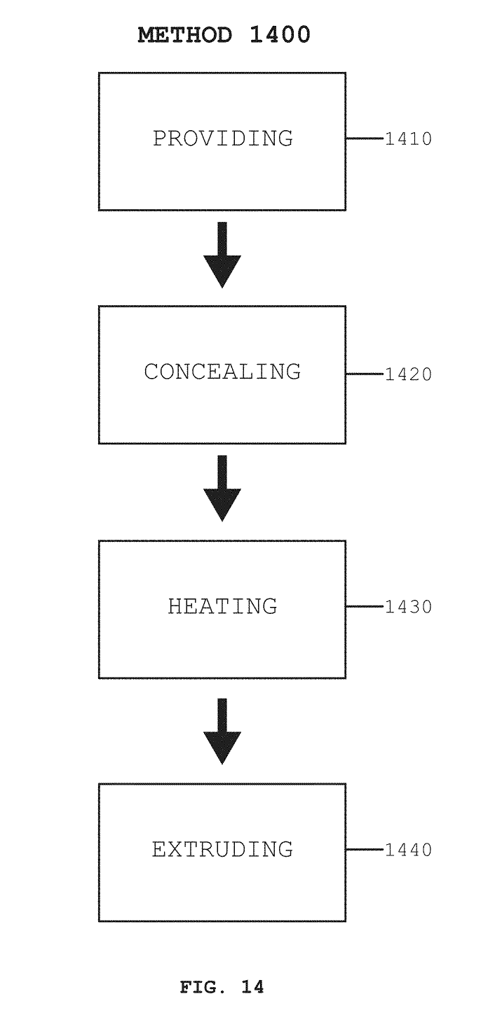

FIG. 14 displays a method for producing yarn in accordance with embodiments. The method may comprise providing synthetic polymer. The synthetic polymer may be heated to at least one of the polymer's glass transition temperature and the polymer's melting temperature. In embodiments, the polymer may be heated in a hopper. The polymer may then be extruded through a spinneret. In embodiments, the spinneret may comprise a restrictor element. In embodiments, a spinneret may comprise a shape restrictor element that may conceal portions of holes found in the spinneret from which fibers may be drawn. The shape restrictor element may essentially shape the fiber so that the fiber may have a smaller thickness or dimension at certain areas of the fibers. The shape restrictor element may be a single piece or may be multiple pieces that may fit over a spinneret. In embodiments, the shape restrictor element may protrude and retract from a position in front of the holes of the spinneret at specific intervals so that fibers may comprise equal lengths of larger diameters and smaller lengths of diameters. In embodiments, the shape restrictor element may be connected to a computing system that may control the shape restrctor element to protrude and retract from a position in front of the holes of the spinneret.

In embodiments, fabric utilized may be knit in a double knit pattern. In embodiments, the double knit fabric may comprise one or more different types of yarn. In embodiments, the one or more different types of yarn may comprise fibers of different thicknesses.

For the purposes this disclosure, the term “thermochromic molecule” may include thermochromic dye molecules and thermochromic pigment molecules.

In embodiments, the article of apparel may comprise at least one of a plurality of stabilizer molecules, a plurality of absorber molecules, and a plurality of blocker molecules. In embodiments, the molecules may be dispersed within thermochromic portions.

It is appreciated that, although one or more FIGS. may display embodiments of pants and tops, the disclosure is not limited to pants and tops and may include other articles of apparel.

It is noted that dye molecules referred to herein (pigment, dye, thermochromic, etc.) may be incorporated into thermochromic portions by conventional standards, unless otherwise disclosed.

In embodiments, at least some of the plurality of thermochromic molecules may comprise a darker value than the value of at least one of the dye molecules and pigment molecules.

In embodiments, warp yarns and weft yarns found in any of the articles of apparel may be selected from the group consisting of: core-spun yarn, blended yarn, ply yarn, cord yarn, boucle yarn, self-striping yarn, and marled yarn.

In embodiments, the textile layer may comprise natural yarns including natural fibers. In embodiments, the textile layer may comprise synthetic yarns including synthetic fibers.

In embodiments, any disclosed article of apparel pattern may include weaves such as, but is not limited to, any of the following: plain weave, twill weave, satin weave, basket weave, leno weave, mock leno weave, and pile weave.

In embodiments, any disclosed article of apparel pattern may include knits such as, but is not limited to, any of the following: knit stitch, purl stitch, elongated stitch, plaited stitch, slip stitch, increase knitting pattern, and decrease knitting pattern.

Examples of blends that various articles of apparel may be made from may include polyester/rayon/spandex blends, such as 47% polyester, 47% rayon, and 6% spandex; or from 30-60% polyester, 30-60% rayon, and 1-20% spandex; such as from 40-50% polyester, 40-50% rayon, and 2-18% spandex, such as from 43-49% polyester, 43-49% rayon, and 3-15% spandex; such as from 45-52% polyester, 45-52% rayon, and 4-10% spandex; including from 35-50% polyester, 40-50% rayon, and 5-8% spandex, and so on. Likewise, a blend of 88% nylon, and 12% spandex may be utilized, or 90:10 nylon:spandex, or anywhere from 70-98% nylon and 2-30% spandex may be used.

In embodiments, fabrics may comprise from 1-6 types of materials, such as from 1, 2, 3, 4, 5, or 6 types of materials. These materials may be present in any amount, including, for example where the blend is 50:50, or 45:55, or 40:60 or 35:65, or 30:70, or 25:75, or 20:80, or 15:85, or 10:90, or 5:95, or each component is present from about 1-99%, such as from 2-95%, or from about 3-98%, or from 4-97%, or 5-90%, or 6-92%, or 7-91%, or 8-96%, or 9-94%, or 10-93%, or 11-89%, or 12-88%, or 87%, or 14-86%, or 15-85%, or 16-84%, or 17-83%, or 18-82%, or 19-81% , or 20-80%, or 21-79%, or 22-78%, or 23-77%, or 24-76%, or 25-75%, or 26-74%, or 27-73%, or 28-72%, or 29-71%, or 30-70%, or 31-69%, or 32-68%, or 33-67%, or 34-66%, or 35-65%, or 36-64%, or 37-63%, or 38-62%, or 39-61%, or 40-60%, or 41-59%, or 42-58%, or 43-57%, or 44-56%, or 45-55%, or 46-54%, or 47-53%, or 48-52%, or 49-51%, or 50% each.

Particular examples of fabric blends in embodiments may include 97% cotton with 3% spandex, or from about 80-99% cotton with about 1-20% spandex, such as a 99:1, or 98:2, or 97:3, or 96:4, or 95:5, or 94:6, or 93:7, or 92:8, or 91:9, or 90:10, or 89:11, or 88:12, or 87:13, or 86:14, or 85:15, or 84:16, or 83:17, or 82:18, or 81:19, or 80:20, or 79:21, or 78:22, or 77:23, or 76:24, or 75:25, or 74:26, or 73:27, or 72:28, or 71:29, or 70:30 cotton:spandex blend, or cotton:polyester blend, or polyester/spandex blend. These materials may be used for one or more of a waistband, legs of a garment, and/or a crotch or other parts of a garment, with any one or more of these parts of a garment being the same or different. Preferred materials and blends can include one or more of organic cotton/spandex, cotton; modal, viscose/spandex, PILAYO (SUPPLEX Nylon/LYCRA Spandex), Heathered PILAYO (SUPPLEX Nylon(Polyester/LYCRA Spandex), or COOLMAX (polyester). The lists of materials and compositions of the fabric provided in this specification are not meant to be exhaustive but only representative of the types of materials and amounts of material that may be used.

In embodiments, the thermochromic molecules may be microencapsulated.

In embodiments, the thermochromic molecules found in. any disclosed textiles may be of any color or may be colorless.

In embodiments, any of the mentioned articles of apparel may include a design made up of a pluraljty of thermochromic molecules. In embodiments, separate portions of the image may each comprise thermochromic molecules with different activation energes. When the article of apparel increases in temperature (such as by the transfer of body heat, the absorption of sunlight, etc.), different thermochromic molecules may be activated at different temperatures and may change color (so that different portions of the design may be viewable at different temperatures).

It is appreciated that certain features of the disclosure, which are, for clarity, described in the context of separate embodiments, may also be provided in combination its a single embodiment. Conversely, various features of the disclosure, which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather the scope of the present disclosure is defined by the appended claims and includes both combinations and sub-combinations of the various features described hereinabove as well as variations and modifications thereof, which would occur to persons skilled in the art upon reading the foregoing description.

1. An article of apparel comprising:
a textile layer;
a thermochromic portion affixed to the textile layer, wherein the thermochromic portion comprises at least one set of thermochromic molecules;
and
a heat protective layer comprising a plurality of heat resistant molecules, wherein the heat protective layer is positioned on a first surface of the thermochromic portion.

2. The article of apparel of claim 1, wherein the thermochromic portion comprises an elastic polymer.

3. The article of apparel of claim 1, wherein at least a portion of the textile layer comprises synthetic fibers.

4. The article of apparel of claim 1, wherein a second surface of the thermochromic portion is adjacent the textile layer and the first surface is positioned opposite the second surface, further wherein the heat protective layer prevents transmission of heat from an external environment to the thermochromic portion.

5. The article of apparel of claim 1, wherein the heat protective layer comprises at least one of silicon dioxide, a metal oxide, a polyphosphazene, and a silicone polymer.

6. The article of apparel of claim 1, wherein the thermochromic portion is affixed to the textile layer via at least one of self-adhesion, a binding agent, ultrasonic agent, ultrasonic welding, and heat treatment.

7. The article of apparel of claim 1, wherein the thermochromic portion is positioned along a border of an orifice defined within the textile portion.

8. The article of apparel of claim 1, wherein at least a portion of the thermochromic portion is positioned within an orifice defined within the textile portion.

9. The article of apparel of claim 1, wherein the at least one set of thermochromic molecules comprises a standard color matching a main color of the textile portion and an activation color different than the standard color.

10. The article of apparel of claim 1, wherein the thermochromic portion further comprises a non-thermochromic dye including a first color, and further wherein the at least one set of thermochromic molecules is colorless at a first temperature range and a second color at a second temperature range.

11. The article of apparel of claim 1, further comprising an intermediary layer positioned between the textile layer and the thermochromic portion, wherein the intermediary layer comprises a thermal conductivity greater than that of the textile layer and the thermochromic portion.

12. The article of apparel of claim 1, wherein the textile layer includes fibers each varying in diameter along the lengths of each of the fibers.

13. A thermochromic patch comprising:
a thermochromic portion affixable to a portion of a textile, wherein the thermochromic portion comprises at least one set of thermochromic molecules; and
a heat protective layer, wherein the heat protective layer is positioned on a first portion of the thermochromic portion;
further wherein the heat protective layer prevents transmission of heat from an external environment to the thermochromic portion.

14. The thermochromic patch of claim 13, wherein the thermochromic portion comprises an elastic polymer.

15. The thermochromic patch of claim 13, wherein the thermochromic portion is affixed to the textile layer via at least one of self-adhesion, a binding agent, ultrasonic welding, and heat treatment.

16. The thermochromic patch of claim 13, wherein at least a portion of the thermochromic portion is positioned within an orifice defined within a portion of a textile.

17. A method for producing a thermochromic article of apparel, comprising:
providing a textile layer;
affixing a thermochromic portion to the textile layer, wherein the thermochromic portion comprises at least one set of thermochromic molecules; and
applying a heat protective layer to the thermochromic portion, wherein the heat protective layer is positioned on a first portion of the thermochromic portion.

18. The method of claim 17, wherein the thermochromic portton is affixed to the textile layer via at least one of self-adhesion, a binding agent, ultrasonic welding, and heat treatment.

19. The method of claim 17, wherein the thermochromic portion is positioned, along a border of an orifice defined within the textile portion.

20. The method of claim 17, further comprising applying a non-thermochromic dye including a first color, and further wherein the at least one set of thermochromic molecules is colorless at a first temperature range and a second color at a second temperature range.
